(19) United States
(12) Patent Application Publication
(10) Pub. No.: US 2013/0046591 A1
(43) Pub. Date: Feb. 21, 2013

(54) SYSTEM AND METHOD FOR COLLABORATIVE BUDGET TRACKING

(71) Applicant: Yifei Yao, Plano, TX (US)

(72) Inventor: Yifei Yao, Plano, TX (US)

(73) Assignee: RECURSION SOFTWARE, INC., Frisco, TX (US)

(21) Appl. No.: 13/211,449

(22) Filed: Aug. 17, 2011

(51) Int. Cl. G06Q 40/00; G06Q 30/00

(52) U.S. Cl. 705/14.4; 705/35

(57) ABSTRACT

To enable collaborative budget tracking, a budget tracker application can be downloaded and installed on a plurality of mobile devices that communicate on a peer-to-peer network. The budget tracker application comprises a master budget control module that enables a budget administrator to create a budget plan and advertise the budget plan to potential subscribers. The budget tracker application also includes an expense recording module that enables subscribers to enter expense data and submit the expense data to the master budget control module which records the expense data, updates the budget plan, and publishes any relevant updates to the subscriber devices.

### FIELD OF THE INVENTION

This disclosure relates to applications that are executable on mobile devices and in particular to applications that allow collaboration between multiple devices. Specific embodiments relate to collaborative budget applications.

### BACKGROUND OF THE INVENTION

A problem with monitoring of expenses incurred by an entity, e.g. an individual, family, business, etc, is that expenses are often incurred at locations isolated from where expenses are recorded, budgets are administered etc. For example, expenses can be incurred at multiple sites, e.g. commercial and retail centers, whereas the means for recording expenses may be at some central office. In addition, incurred expenses may not be incorporated into the budget until some much late time, thus making it difficult to know the real-time state of a budget. This can be particularly troublesome where multiple persons are allowed to incur expenses.

What is required is an improved system and method for administering a budget.

### SUMMARY OF THE INVENTION

To enable collaborative budget tracking, a budget tracker application can be provided that can be downloaded and installed on a plurality of mobile devices. The budget tracker application may enable a budget administrator to create a budget plan and advertise the budget plan to potential subscribers. The budget tracker application may also enable subscribers to enter expense data and submit the expense data to the master budget control module which records the expense data, updates the budget plan, and publishes any relevant updates to the subscriber devices.

In one aspect of the disclosure, there is provided a method for managing a budget comprising executing a master budget control module in a first device. Executing the master budget control module may enable the application to create a budget plan and receive one or more expense records into the first device from at least one second mobile device. The master budget control module may incorporate at least one expense record into the budget plan.

In one aspect of the disclosure, there is provided a method for contributing to a collaborative budget plan. A first mobile device may subscribe to a budget plan hosted on an administration device. An expense record may be generated in the first mobile device and communicated to a master budget control module of the administration device.

In one aspect of the disclosure, there is provided a collaborative budget application configured to execute on a plurality of mobile devices. The collaborative budget application may comprise an expense recording module and a master budget control module. The expense recording module may be configured to generate at least one expense record that indicates at least one expenditure and communicate the expense record to a master budget control module of an administration device. The master budget control module may be configured to receive one or more expense records and update a budget plan with data from the received one or more expense records.

### BRIEF DESCRIPTION OF THE DRAWINGS

Reference will now be made, by way of example only, to specific embodiments and to the accompanying drawings in which:

FIG. 1 schematically shows a network of mobile devices that each execute a budget tracker application;

FIG. 2 schematically depicts the modules of the budget tracker application;

FIG. 3 depicts a flowchart of a method for managing a budget;

FIG. 4 depicts a creating and publishing a budget plan;

FIG. 5 depicts creating and recording an expense record;

FIG. 6 depicts the operation of an expense recording module; and

FIG. 7 depicts the operation of a controller module.

### DETAILED DESCRIPTION OF THE INVENTION

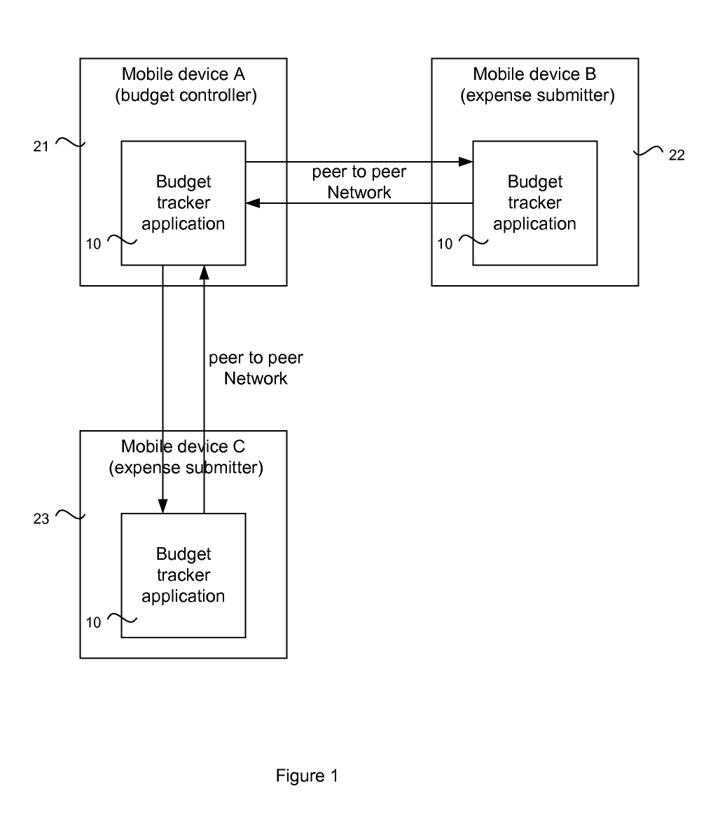

In FIG. 1, there is shown a budget tracker application 10 that can be deployed to multiple mobile devices 21, 22, 23 to enable tracking of a budget. In the example depicted in FIG. 1, device A 21 is indicated as a budget controller. In various embodiments, the budget controller may or may not be a mobile device. Device B 22 and Device C 23 are each designated as expense submitters. Device A 21, device B 22 and device C 23 may communicate with each other on a peer to peer network. An example of a pervasive platform for enabling peer to peer communication is described in the present assignee's co-pending patent application Attorney Docket No. 20091113.1, the entire contents of which are herein incorporated by reference.

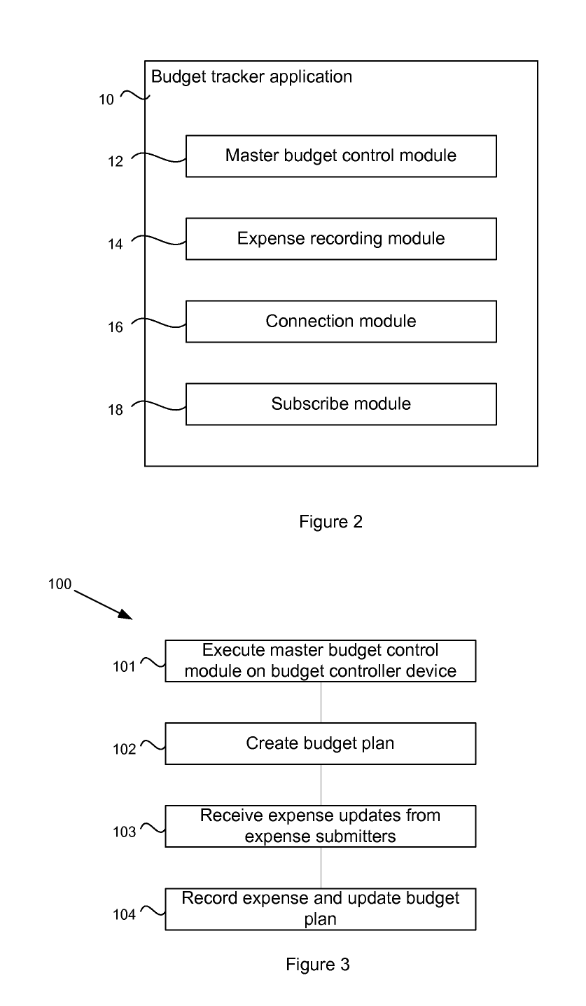

An embodiment of the budget application is depicted in more detail in FIG. 2. The budget application 10 may include a master budget control module 12, an expense recording module 14, a connection module 16 and a subscribe module 18. The budget tracker application may be provided as a downloaded application from a host website, as is known in the art. Users may download and install the budget tracker application 10 onto their mobile device.

In various instances of the budget application 10, not all of the modules 12, 14, 16, 18 may be enabled. For example, the master budget control module may be enabled only for the budget controller (e.g. device A 21) and may be disabled for devices that are considered as expense submitters (e.g. device B 22 and device C 23).

In some embodiments, the budget tracker application 10 may be provided as separately installable modules, so that a device to be used as a budget controller may download all modules, while devices to be used as expense submitters may only download and/or only install the expense recording module 14, connection module 16 and subscribe module 18.

A method for managing a budget is depicted in the flowchart 100 of FIG. 3. At step 101, the master budget control module is executed in the budget controller device 21. At step 102, an interface of the master budget control module is used by a user to create a budget plan. At step 103, expense records are received into the budget controller from one or more expense submitters and incorporated into the budget plan (step 104).

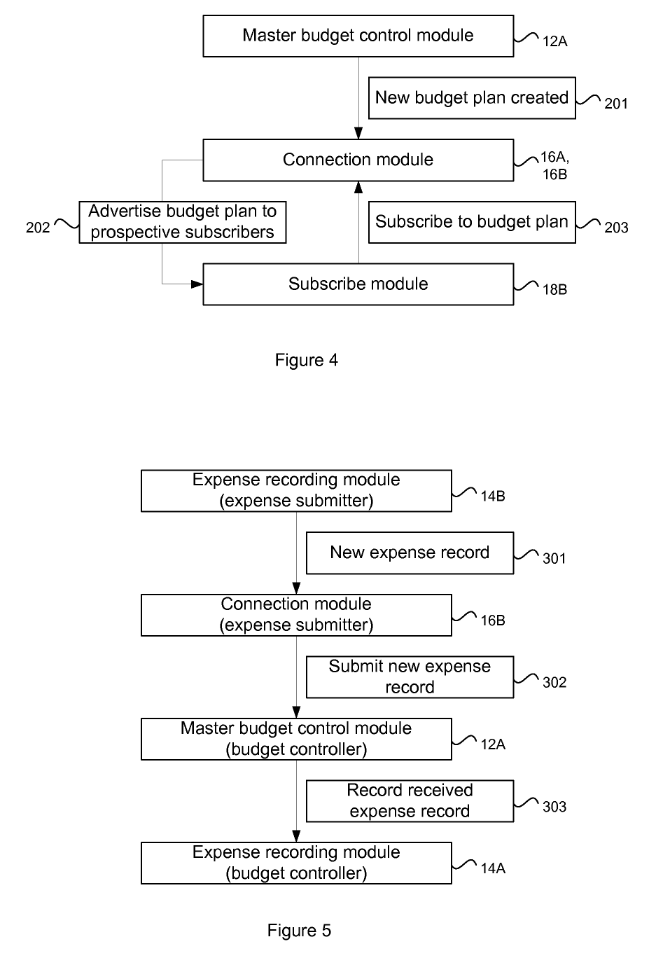

An example of the process for creating a budget plan is depicted in FIG. 4. At step 201, a budget administrator invokes the master budget control module 12A on Device A 21 (FIG. 1) to create a new budget plan. A budget plan interface is displayed on the budget administrator's device and provides a form enabling the budget administrator to enter details such as a budget plan name or other budget plan ID, a budget controller ID, a budget limit, expense categories, expense limits per category, a list of authorized expense submitters, a list of eligible expenditures, descriptive fields such as a purpose of the budget plan, etc. The budget plan may set limits on particular subscribers, particular expense categories, or overall expenditure limits.

At step 202, the budget plan is advertised to prospective subscribers to the budget plan. In one embodiment, the list of users may be derived from the eligible expense submitters field of the budget plan. Alternatively, the budget administrator may input specific members (e.g. via mobile device numbers) to whom the budget plan will be advertised. The connection module 16A of the administrator device then notifies each member of the list of users that the budget is available to subscribe. When an expense submitter device, e.g. device B 22, receives an advertisement of the budget plan, the user may invoke the subscribe module 18B on their respective device. The subscribe module 18B of a user device, allows a user to select a budget plan, e.g. by budget plan ID, and to respond to the budget controller device 21, via the respective connection modules 16A, 16B of the respective devices, with a subscribe request that may include a user ID as well as a device ID (step 203). The subscribe request is received at the subscribe module of the budget controller device 21 and the device ID of the subscriber is added to a list of subscribed devices for the budget plan. The budget plan subscription provides a list of devices that are authorized to submit expense records for the budget plan.

In one embodiment, a device ID provided in a subscription request may be automatically subscribed to the budget plan without notification or intervention from the budget administrator. In an alternative embodiment, the receipt of a subscription request at the budget controller device may be notified to the budget administrator, thereby allowing the budget administrator to specifically authorize the subscription of a user and/or device.

Once a user/device has been subscribed to the budget plan, the user is able to invoke the expense recording module 14 on their device to submit expense records, as depicted in FIG. 5. When the expense recording module 14B is invoked, the user may be prompted to select a budget plan from a list of budget plans to which the device is subscribed. Selection of the appropriate budget plan ensures that the expense record is submitted to the correct budget controller device. The expense recording module 14B then creates an expense record form that enables the user to enter details of an expenditure (step 301). Details may include the item or service purchased, the amount, an expense category, the date and time of the purchase, payment type (credit, check or cash) etc. Details such as a user ID and/or device ID may be automatically filled in.

When the user has completed the expense record, the expense submitter device connects to the budget controller device via the connection module 16B and the expense record is submitted to the budget control module of the budget controller device (step 302). The master budget control module 12A of the budget controller device receives the received expense record an passes it to the local expense recording module 14A which updates the budget plan (step 303). Updating of the budget plan may include adding the expense amount to a total expenditure field and allocating the expense amount to the submitting user's expenditure total.

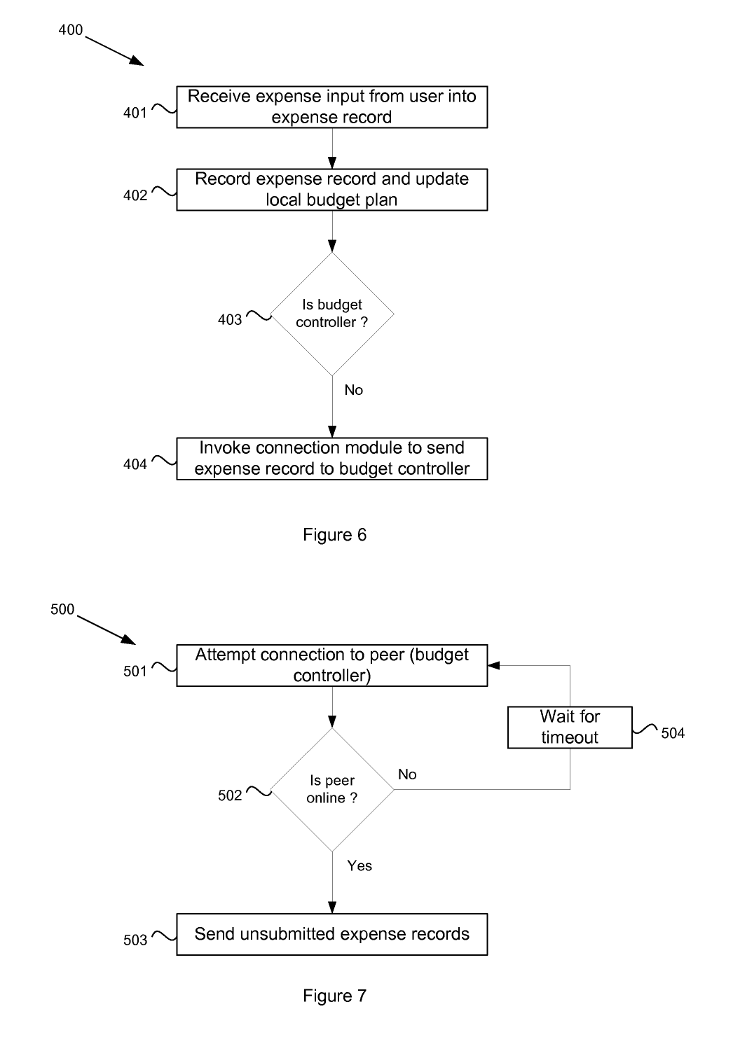

A process for recording expenses is depicted in the flowchart 400 of FIG. 6. At step 401, the expense recording module receives an expense input from the user. At step 402, the expense recording module may update a local version of the budget plan on the device. At step 403, the expense recording module determines if the local device is the budget controller for the respective budget plan, e.g. by referencing a budget controller ID field of the budget plan. If the device is the budget controller, then the local version of the budget plan is the master version and so no further action is taken. If the device is not the budget controller for the budget plan, then the device invokes the budget tracker application's connection module 16 to connect to the budget controller for submitting the expense record (step 404). In one embodiment, a connection to the budget controller may be attempted as soon as an expense record is recorded locally at the device. In alternative embodiments, expense records may be submitted periodically, e.g. every 5 minutes. In a further alternative, the submission of expense records to the budget controller may be specifically initiated by the user.

The process undertaken by the connection module 16 is depicted in the flowchart 500 of FIG. 7. At step 501, the connection module attempts to establish a connection to the peer (budget controller). If the peer is online (determination 502), then any unsubmitted expense records are sent 503. If the peer is not online, then the connection module waits a timeout period (step 504), e.g. one hour, and attempts to re-submit the expense records, continuously waiting and re-attempting until the expense records have been submitted. Whenever a subscribing device connects to the device that administers the master budget plan, the subscribing device may receive one or more updates of the budget plan. The updates may relate to the global budget plan, such as an indication of the available amount remaining on a particular budget, or the updates may relate to the specific subscriber.

As described above, the master budget control module 12 may allow a user to administer a budget that has multiple subscribers. Also indicated above, the master budget control module may be invoked to locally administer a budget plan that the user subscribes to and that is hosted on a separate device. That is, the user is able to use the master budget control module to locally administer their component of a broader budget plan.

The master budget control module 12 may include a summary function that displays to the budget administrator various details of the budget plan. The budget plan summary may list parameters such as the total amount spent to date, a rate of spend, a projected date on which the budget limit will be reached, a highest spending subscriber, etc. Statistics may be sorted according to date, size of purchase, purchase category, subscriber, etc. The master budget control module may also list the amounts that need to be reimbursed to expense submitters for expenses that have been incurred. Many of these statistics can also be provided at a local level for a subscriber to the budget plan.

In one embodiment, the interface through which a budget administrator creates and administers a budget plan may allow the budget administrator to set one or more alerts. Alerts may be set for parameters such as total expenses, expense per subscriber, rate of expenditure, and single expenditures, such as where an expense above a threshold level is received. Threshold alert levels may be set at absolute values, as percentages of the values, or may be rate dependent, such as an expenditure per given day, week, month, quarter, year, etc.

When the master budget control module detects that an alert level has been reached, the budget administrator may be alerted, e.g. by activating an alarm or tone on the budget controller device 21. In addition, updates may be sent to the subscribers. For example, if the total of the expense records received exceeds an expenditure level, such as 90% of the total budget limit, the master budget controller may generate an expenditure alert and publish the expenditure alert as a budget update to the devices that are subscribed to the budget plan. Thus, subscribers are made aware that the budget plan is approaching its expenditure limit. An additional alert and update may be sent if the budget reaches the total limit.

In one embodiment, the budget alert may be provided to all subscribers to the budget or only to those relevant subscribers, such as a subscriber that has reached a personal expenditure limit. In one embodiment, the budget alert may be provided to a budget administrator. Such an alert may allow the administrator to modify the budget, e.g. by adding more funds to an account associated with the budget and to indicate in the budget plan that additional funds are available. In another example, the budget administrator may be alerted whenever the master budget control module receives an expense record that is above a pre-determined amount.

In one embodiment, the budget plan may require expenditure requests be submitted prior to authorizing a purchase. In this embodiment, a modified expense recording module allows a subscriber to submit an expenditure request to the master budget control module of the budget controller device. When an expenditure request is received at the master budget control module, the budget administrator is alerted and can respond with an indication of whether the expenditure request is authorized. An expenditure request ID and an authorization ID may be added to an expense record to facilitate administering of the authorization process.

In order to prevent the budget administrator from being notified of every expenditure request, including for relatively minor expenses, the budget plan may enable the budget administrator to set a pre-approval expense amount. Expense requests below the pre-approval limit may be automatically authorized. Expense requests above the pre-approval limit may be specifically notified to the budget administrator, e.g. be activating an alert tone on the budget controller's device,

The budget tracker application 10 may be embodied in hardware, software, firmware or a combination of hardware, software and/or firmware. In various embodiments, components of the application may be provided as computer executable instructions stored in a memory of the various mobile devices that can be executed by one or more processors of the mobile devices.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

1. A method for managing a budget comprising:
executing a master budget control module in a first mobile device, executing the master budget control module comprising:
creating a budget plan;
receiving at least one expense record into the first device from at least one second mobile device; and
incorporating the at least one expense record into the budget plan.

2. The method of claim 1 comprising receiving the at least one expense record through a peer-to-peer network.

3. (canceled)

4. The method of claim 1 comprising advertising the budget plan to the at least one second mobile device.

5. The method of claim 4 comprising:
receiving an indication of the budget plan into the at least one second mobile device;
generating a subscription request in the at least one second mobile device; and
providing the subscription request from the at least one second mobile device to the first device.

6. The method of claim 4 comprising receiving a subscription request from at least one second mobile device and subscribing the requesting device to the budget plan.

7. The method of claim 6 comprising publishing one or more budget plan updates to one or more devices subscribed to the budget plan.

8. The method of claim 7 wherein the one or more updates comprise at least one expenditure alert.

9. The method of claim 1 comprising:
receiving an expenditure request from a requesting device into the master budget control module;
referencing the budget plan to determine an approval for the expenditure request; and
providing an indication of the approval to the requesting device.

10. (canceled)

11. (canceled)

12. (canceled)

13. (canceled)

14. (canceled)

15. (canceled)

16. (canceled)

17. (canceled)

18. (canceled)

19. (canceled)

20. (canceled)
